(19) United States
(12) Patent Application Publication
(10) Pub. No.: US 2014/0160388 A1
(43) Pub. Date: Jun. 12, 2014

(54) LIQUID CRYSTAL DISPLAY APPARATUS

(71) Applicant: HANNSTAR DISPLAY CORPORATION, New Taipei City (TW)

(72) Inventors: Hsu-Ho Wu, Tainan City (TW); Chia-Hua Yu, New Taipei City (TW); Feng-Wei Kuo, Pingtung County (TW); Shih-Hsuan Liu, Taoyuan County (TW)

(73) Assignee: HannStar Display Corporation, New Taipei City (TW)

(21) Appl. No.: 13/907,294

(22) Filed: May 31, 2013

Related U.S. Application Data
(63) Continuation of application No. 13/710,092, filed on Dec. 10, 2012.

(51) Int. Cl. G02F 1/1335; G02F 1/1362

(52) U.S. Cl. CPC G02F 1/133526; G02F 1/13362; G02F 1/136286
USPC 349/43; 349/95; 349/62

(57) ABSTRACT

A liquid crystal display device is provided. The device includes a liquid crystal display panel, a grey lever inversion compensation film and a light enhancement module. The liquid crystal display panel has a relatively high aperture ratio, a display side and a rear side. The grey level inversion compensation film is disposed on the liquid crystal display panel at the display side. The light enhancement module is disposed on the liquid crystal display panel at the rear side.

### CROSS REFERENCE TO RELATED APPLICATIONS

This application is a continuation of U.S. patent application Ser. No. 13/710,092 filed Dec. 10, 2012, the contents of which is hereby incorporated by reference herein.

### FIELD

The present invention generally relates to a liquid crystal display device, and in particular to a liquid crystal display device having a grey level inversion compensation film.

### BACKGROUND

In recent years, a transmissive liquid crystal display (LCD) device has been rapidly developed and applied to various uses. The conventional LCD technologies in the state of the art are commonly classified into the following modes: a multi-domain vertical alignment (MVA) mode LCD, an in-plane switching (IPS) mode LCD and a twisted nematic (TN) mode LCD, in accordance with the twisting pattern for the liquid crystal (LC) molecules in the LCD device. Among these modes, the TN mode LCD is most popularly used owing to the overwhelm advantages regarding the high definition and the high transmittance thereof.

Inside the TN mode LCD configuration, the LC molecules are arranged between an upper alignment film and a lower alignment film. The upper and lower alignment films respectively have a first and second rubbing orientation for arranging the LC molecules horizontally aligning in the first and second rubbing orientations. In an off state, the static LC molecules horizontally sandwiched between the upper and lower alignment films are thus spirally twisted from the first orientation to the second orientation and exhibit a twisted nematic alignment having a twisted angle. In an on state, the electric filed applied between the upper and lower alignment films activates the LC molecules having a director in a tendency to be vertically aligned which is perpendicular to the upper and lower alignment films.

FIG. 1(a) is a perspective schematic diagram illustrating a viewing angle from an observer viewing the conventional TN mode LCD device, and FIG. 1(b) is a cross-sectional-viewed schematic diagram illustrating a viewing angle from an observer viewing the conventional TN mode LCD device as correspondingly shown in FIG. 1(a). The TN mode LCD device 100 has a display face 110 having a front-face direction p, also referred to as a normal direction. A reference direction q is set to be downward and coplanar with the display face 110, where the front-face direction p and the reference direction q are mutually perpendicular.

Often, the TN mode LCD device 100 is viewed not only in a front-face direction p but also in various directions t or t′ corresponding to various angles −α and α. Under such circumstances, it finds that a grey level is properly display when the screen for the TN mode LCD device is viewed from a normal direction p. However, a gray level inversion phenomenon may respectively take place when the screen for the TN mode LCD device is viewed from a downward tilt direction t at a critical downward viewing angle −α, and the display quality deteriorates correspondingly. The grey level inversion phenomenon can be simply recognized when the luminance for a gray level supposed to show a black state becomes higher than that for a gray level supposed to show a white state, when the downward viewing angle is lesser than a critical value, which results in “gray level inversion”.

FIG. 1(c) is a graph showing a measurement result of the luminance in relation to a viewing angle at each grey level wherein the measurement result demonstrates a grey level inversion phenomenon for the conventional TN mode LCD device. Referring to FIG. 1(c), it can be indentified that a grey level inversion occurs approximately at the region G where a viewing angle is ranged between −45 to −55 degrees, since the transmission rate, a.k.a. the luminance, for viewing angles lesser than −45 degrees becomes reversal.

In brief, the grey level inversion phenomenon may cause the screen for the TN mode LCD to become more unsightly, leading to degradation in image quality. Accordingly, there is a need to solve the above-mentioned grey level inversion deficiencies/issues for the TN mode LCD device.

### SUMMARY

In a liquid crystal display device, the device includes a liquid crystal display panel, a grey lever inversion compensation film and a light enhancement module. The liquid crystal display panel has a relatively high aperture ratio, a display side and a rear side. The grey level inversion compensation film is disposed on the liquid crystal display panel at the display side. The light enhancement module is disposed on the liquid crystal display panel at the rear side.

In a liquid crystal display device, the device has a liquid crystal display panel and a light enhancement module. The liquid crystal display panel has a grey level inversion, a first side and a second opposite side. The device includes a compensation film and a light enhancement module. The compensation film is disposed on the first side for compensating the grey level inversion. The light enhancement module has a first and a second prism sheets and is disposed on the second opposite side for enhancing and collimating a light emitting from the second opposite side. The first prism sheet has a first featured orientation in a range from 10 to 80 degrees and the second prism sheet has a second featured orientation in a range from 100 to 170 degrees.

In a liquid crystal display device, the device includes a liquid crystal display panel and an optical compensation film. The liquid crystal display panel has a grey scale inversion viewing angle and a display side. The optical compensation film is disposed on the liquid crystal display panel at the display side for compensating the grey scale inversion viewing angle for at least 10 degrees.

In a liquid crystal display device, the device includes a liquid crystal display and a grey level inversion compensation film. The liquid crystal display panel has a display side. The grey level inversion compensation film is disposed on the liquid crystal display panel at the display side.

A more complete appreciation of the invention and many of the attendant advantages thereof are readily obtained as the same become better understood by reference to the following detailed description when considered in connection with the accompanying drawing, in which:

### DESCRIPTION OF THE DRAWINGS

FIG. 1 (a) is a perspective schematic diagram illustrating a viewing angle from an observer viewing the conventional TN mode LCD device.

FIG. 1(b) is a cross-sectional-viewed schematic diagram illustrating a viewing angle from an observer viewing the conventional TN mode LCD device as correspondingly shown in FIG. 1(a).

FIG. 1(c) is a graph showing a measurement result of the luminance in relation to a viewing angle at each grey level which result demonstrates a grey level inversion phenomenon for the conventional TN mode LCD device.

FIG. 2 is a cross-sectional-viewed exploded schematic diagram illustrating a structural layout for a liquid crystal display device having a grey level inversion compensation film in accordance with the present invention.

FIG. 3 is a cross-sectional view schematic diagram illustrating an exemplary embodiment for the grey level inversion compensation film in accordance with the present invention.

FIG. 4(a) is a perspective-viewed exploded schematic diagram illustrating an exemplary embodiment for the light enhancement module in accordance with the present invention.

FIG. 4(b) is a cross-section-viewed schematic diagram illustrating the prism sheet in accordance with the present invention.

FIGS. 5(a) and 5(b) are cross-sectional-viewed schematic diagrams illustrating an exemplary embodiment for the light guide plate in accordance with the present invention.

FIG. 6 is an exploded schematic diagram illustrating an exemplary embodiment for the light adjustment assembly in accordance with the present invention.

FIG. 7 is a graph showing a first exemplary measurement result of the luminance in relation to a viewing angle at each grey level, while the light enhancement module is in configuration with the grey level compensation film and has the first included angle set in 20 degree and the second included angle set in 110 degree, in accordance with the present invention.

FIG. 8 is a graph showing a second exemplary measurement result of the luminance in relation to a viewing angle at each grey level, while the light enhancement module is in configuration with the grey level compensation film and has the first included angle set in 45 degree and the second included angle set in 135 degree, in accordance with the present invention.

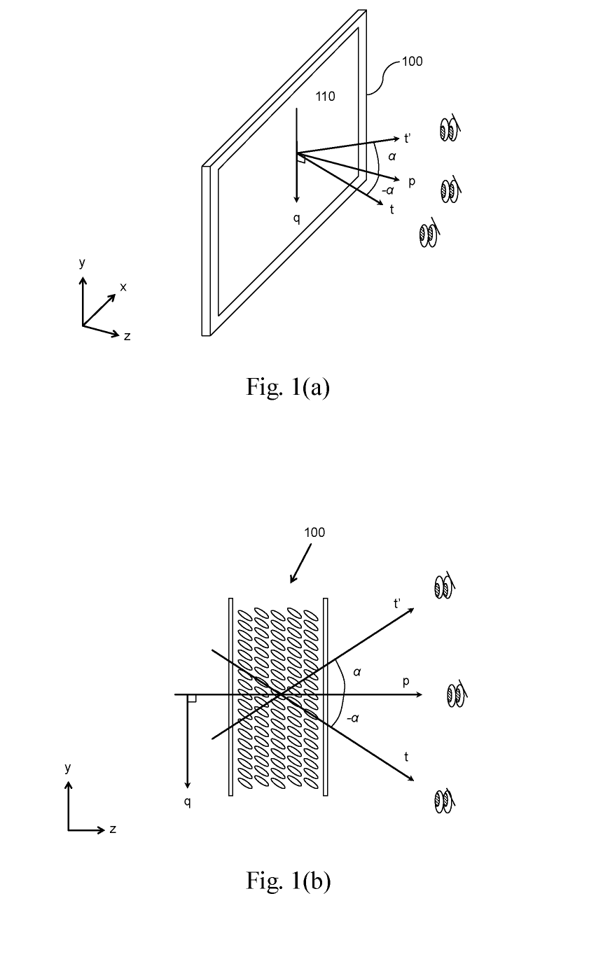

### DETAILED DESCRIPTION

The present invention will be described with respect to particular embodiments and with reference to certain drawings, but the invention is not limited thereto but is only limited by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice.

The invention will now be described by a detailed description of several embodiments. It is clear that other embodiments can be configured according to the knowledge of persons skilled in the art without departing from the true technical teaching of the present invention, the claimed invention being limited only by the terms of the appended claims.

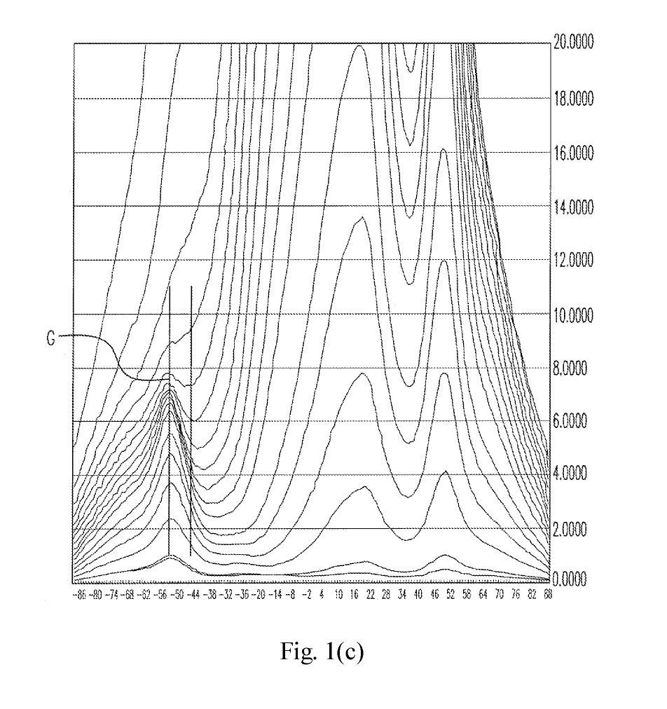

FIG. 2 is a cross-sectional-viewed exploded schematic diagram illustrating a structural layout for a liquid crystal display device having a grey level inversion compensation film in accordance with the present invention. As shown in FIG. 2, the liquid crystal display (LCD) device 200 mainly includes a LCD panel 220, a grey level inversion compensation film 230 and a light enhancement module 240. The LCD device 200 has a front display side FDS and a rear non-display side RNS. In one embodiment, the grey level inversion compensation film 230 is disposed on the LCD panel 220 at the front display side FDS and the light enhancement module 240 is disposed on the LCD panel 220 at the rear non-display side RNS.

The LCD panel 220 is preferably a LCD panel having a relatively high aperture ratio (HAR) structure, such as what is disclosed in the U.S. patent application Ser. No. 13/619,307, filed in United States on Sep. 14, 2012 and entitled as “liquid crystal display panel and pixel array substrate thereof”, which is hereby incorporated by reference as if fully set forth herein. The LCD panel 220 further has the front display side FDS and the rear non-display side RNS, which respectively coincide with the front display side FDS and the rear non-display side RNS that the LCD panel 220 has. The front display side FDS is a viewable face on the LCD device 200 and the LCD panel 220 and facing toward a viewer. The LCD panel 220 further includes a color filter layer 221, a pixel array layer 222 and a liquid crystal (LC) layer 223. The pixel array layer 222 further includes a first substrate 224 and a thin film transistor (TFT) array layer 225 including an array of TFTs and formed thereon. The color filter layer 221 further includes a second substrate 226 and a color filter array layer 227 including an array of color filters and formed thereon.

In one embodiment, there is preferably a pair of first and second polarizer layers 251 and 261 respectively disposed on the color filter layer 221 and the pixel array layer 222 of the LCD panel 220 at the front display side FDS and the rear non-display side RNS, and there is preferably a pair of first and second wide view films 252 and 262 disposed between the color filter layer 221 and the polarizer layer 251 and the pixel array layer 222 and the polarizer layer 261. In one embodiment, the grey level inversion compensation film 230 is disposed on the polarizer layer 251 at the front display side FDS, and the light enhancement module 240 is disposed on the polarizer layer 261 at the rear non-display side RNS.

Usually, there is a backlight module 270 including a light source 271 and a light guide plate 272 and disposed on the light enhancement module 240 in the LCD device 200 at the rear non-display side RNS. The light source 271 is used for providing a light to the light guide plate 272 and the light guide plate 272 receives it, transforms it into a surface light source and provides it for the transmissive LCD panel 220.

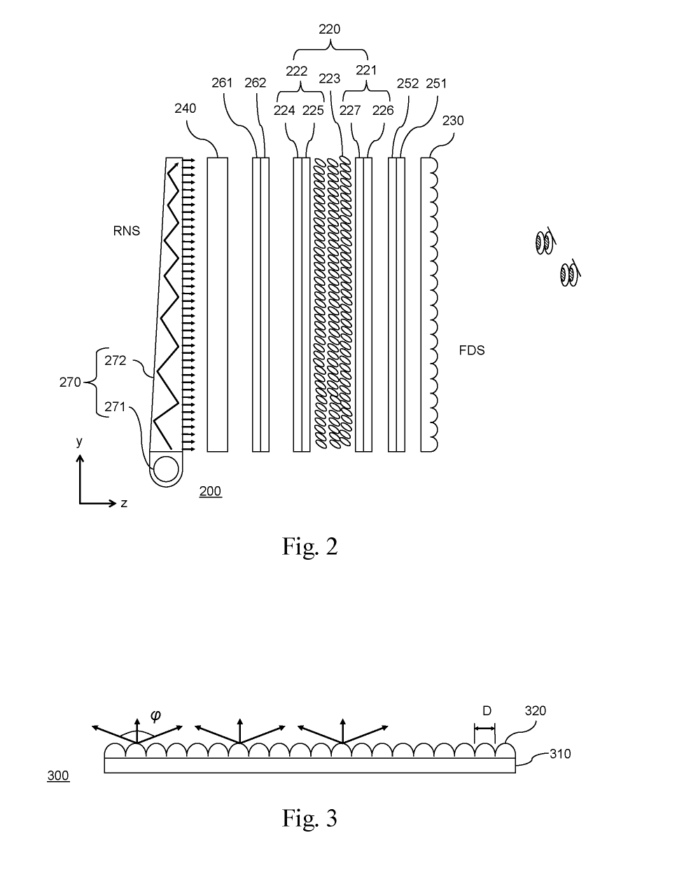

FIG. 3 is a cross-sectional view schematic diagram illustrating an exemplary embodiment for the grey level inversion compensation film in accordance with the present invention. The grey level inversion compensation film 300 includes a substrate 310 and multiple micro-structures 320 formed on the substrate 310. In this embodiment, each micro-structures 320 is preferably a convex micro-lens 320 and has a diameter D in a range from 0.3 μm to 300 μm, preferably in a range from 20 μm to 30 μm. The multiple convex micro-lenses 320 are formed in a two-dimension arrayed formation on the substrate 310.

The multiple convex micro-lenses 320 can refract the light passing through in a relatively large refracting angle φ in comparison with the refracting angle that the LCD panel without the compensation film having the convex micro-lenses has, which causes the light passing though to be scattered and results in a relatively wide viewing angle at the same time, for compensating the grey level inversion viewing angle under which the grey level inversion may be observed. That is to say, the light emitted from the liquid crystal display panel and passing through the convex micro-lens is refracted and scattered in a relatively large refracting angle by the multiple convex micro-lenses. In one embodiment, it is measured and obtained that the optical compensation film 300 can preferably compensate the grey level inversion viewing angle for at least 10 degrees.

Commonly, the displaying gray level for the TN mode LCD device depends on the transmittance that the LC molecules layer has and is determined by the vertical director of LC molecules layer. Thus the transmittance is controlled by the applied electric field to the LC molecules layer. Subject to the same given electric field at different viewing angles, the relationship between applied electric field and transmittance shall maintain linear regardless of viewing angle. However, while a relatively lower electric field inversely produces the relatively lower transmittance that a relatively higher electric field is supposed to produce, a reversal occurring at that angle where the scene that should be more bright inversely becomes more dark, which results in a serious defect called gray level inversion. In other words, the gray level inversion is also referred to as the phenomenon that the transmission rate is high at a higher application voltage rather than a lower application voltage above a certain angle.

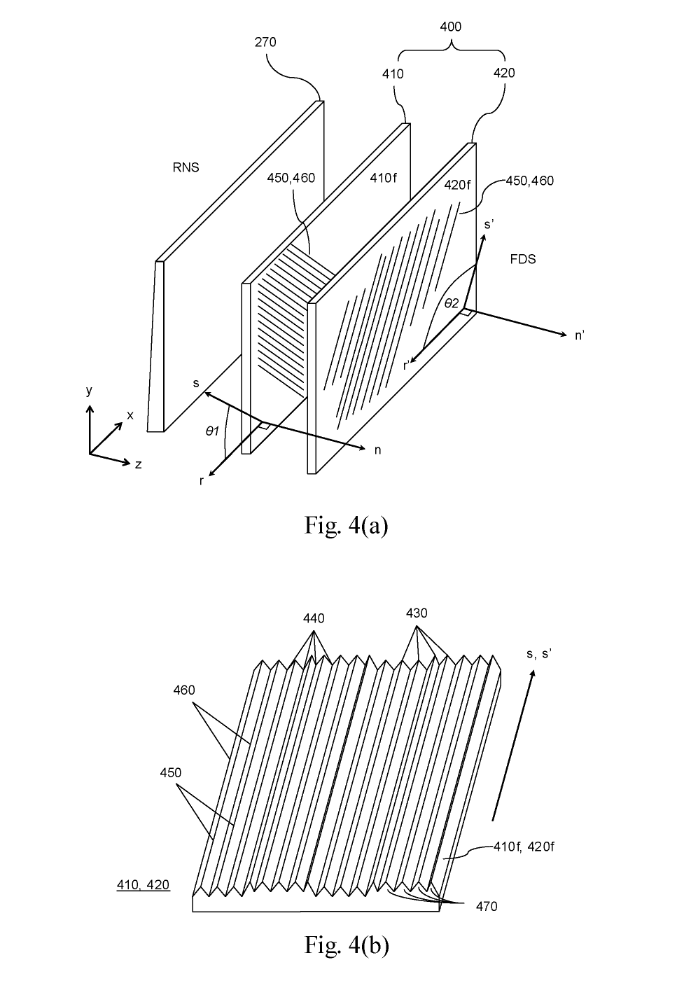

FIG. 4(a) is a perspective-viewed exploded schematic diagram illustrating an exemplary embodiment for the light enhancement module in accordance with the present invention. In this embodiment, the light enhancement module 400 includes dual prism sheets, a first prism sheet 410 and a second prism sheet 420. The light enhancement module 400 is disposed in front of the backlight module 270 and at the front display side FDS in the LCD device 200 as shown in and in reference with FIG. 2. The light enhancement module 400 is used for uniforming, concentrating, enhancing and collimating the backlight emitted from the backlight module 270. The first prism sheet 410 and a second prism sheet 420 are aligned and overlapped with each other contiguously or adjacently as shown in FIG. 4(a). Each first and the second prism sheets 410 and 420 has a front surface 410f and 420f and a rear surface (not shown in FIG. 4(a)) respectively opposite to the front surface 410f and 420f.

In FIG. 4(a), the front surface 410f on the first prism sheet 410 has a first normal direction n that is on the z axis and is perpendicular to the front surface 410f, and has a first reference orientation r that is coplanar with the front surface 410f and is set to be horizontal, where the first normal direction n and the first reference orientation r are mutually perpendicular. Similarly, the rear surface 420f on the second prism sheet 420 also has a second normal direction n′ that is on the z axis and is perpendicular to the rear surface 420f, and has a second reference orientation r′ that is coplanar with the rear surface 420f and is set to be horizontal, where the first normal direction n′ and the first reference orientation r′ are mutually perpendicular. In this embodiment, the first and second normal directions n and n′ point toward the same direction and the first and second reference orientations r and r′ point toward the same direction as well.

FIG. 4(b) is a cross-section-viewed schematic diagram illustrating the prism sheet in accordance with the present invention. As shown in FIG. 4 (b), each first and the second prism sheets 410 and 420 consists of multiple contiguous aligned prism units 470, each of which prism units 470 have the same or different shape from each other. Each prism unit 470 has a top surface in various shapes, for example, in a shape being one selected from group consisting a polygon shape, a diamond shape, a prism shape, a round shape, a triangular shape, an undulated shape, a saw shape, a zigzag shape and a combination thereof. Therefore, the front surfaces 410f and 420f on each first and the second prism sheets 410 and 420 consisted of multiple contiguous aligned prism units 470 have a shape being one selected from group consisting an undulated shape, a saw shape, a zigzag shape and a combination thereof.

Each prism sheets 410 and 420 further has multiple crest points 430 and multiple trough points 440 situated at the common boundary for dual neighboring prisms formed on the front surfaces 410f and 420f. The crest point 430 and the trough point 440 are continuously elongated toward and extend along a specific orientation in straightness over the front surfaces 410f and 420f, so as to form multiple ridge lines 450 and valley lines 460. Each ridge lines 450 and valley lines 460 are actually arranged in parallel with one another, and collectively form the first and second arrangement orientations s and s′ for the respective prism sheets 410 and 420. In other words, the first and second prism sheets 410 and 420 respectively has the first and second arrangement orientations s and s′ consisting of the multiple ridge lines 450 and valley lines 460 parallel with one another.

Often, the first and second arrangement orientations s and s′ are preferably perpendicular or parallel with edges of the prism sheet. In one embodiment, the respective first and second arrangement orientations s and s′ respectively has an included angle with the edges of the prism sheet. Using the above-mentioned coordinate system shown in FIGS. 4(a) and 4(b), there is further shown includes angles. A first included angle θ1 is accordingly defined as an angle between the first arrangement orientation s and the first reference orientation r, and a second included angle θ2 is accordingly defined as an angle between the second arrangement orientation s′ and the second reference orientation r′. That is to say, the first prism sheet 410 and the second prism sheet 420 are crossed at a certain angle with each other.

While the light enhancement module 240, 400 and the grey level compensation film 230, 300 are configured to form the LCD device 200 as shown in FIG. 2, the grey level inversion viewing angle under which the grey level inversion may be observed can be well compensated for at least 10 degrees. In this embodiment, after duly measurement, it is obtained that the first included angle θ1 is preferably in a range from 10 to 80 degrees, and a second included angle θ2 is preferably in a range from 100 to 170 degrees. Preferably, while the first included angle θ1 is in 20 degree, the second included angle θ2 is in 110 degree, and while the first included angle θ1 is in 45 degree, the second included angle θ2 is in 135 degree.

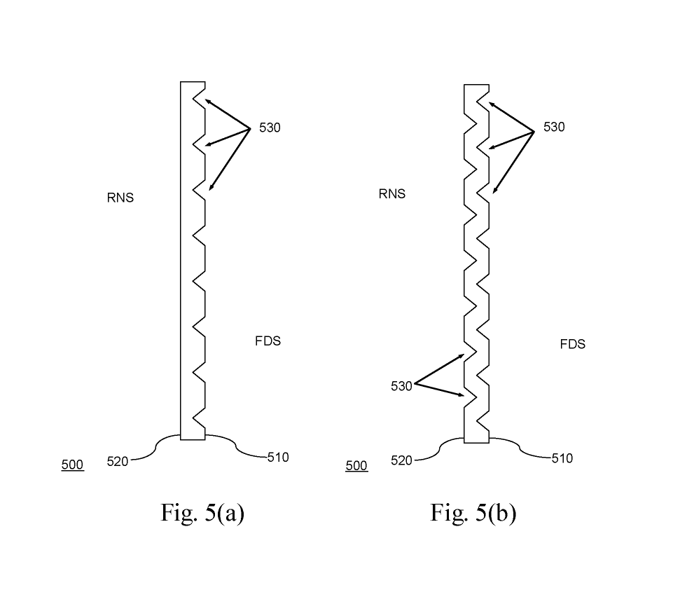

FIGS. 5(a) and 5(b) are cross-sectional-viewed schematic diagrams illustrating an exemplary embodiment for the light guide plate in accordance with the present invention. In this embodiment, the light guide plate 500 has two surfaces, a first surface 510 and a second surface 520, which are opposite to each other. There are multiple grooves 530 formed on one of the first surface 510 and the second surface 520 and formed into the primary body the light guide plate 500 has. For example, there are multiple grooves 530 formed on the first surface 510 as shown in FIG. 5(a), the second surface 520 or both the first surface 510 and the second surface 520 as shown in FIGS. 5(a) and 5(b). The multiple grooves 530 have a cross section in a shape being one selected from a group consisting of a V-cut shape, a triangular shape, a rectangular shape, a circular shape, a polygon shape, an arc shape and a combination thereof. In this embodiment, the respective multiple grooves 530 preferably have a cross section in a V-cut shape.

In this embodiment, the light guide plate 500 is functioned to provide feature as follows. When a visible brightness is reduced to a half of a front-view brightness (that is viewed from the front normal direction), the viewing angle, also referred to as a half-brightness viewing angle, is less than 20 degrees.

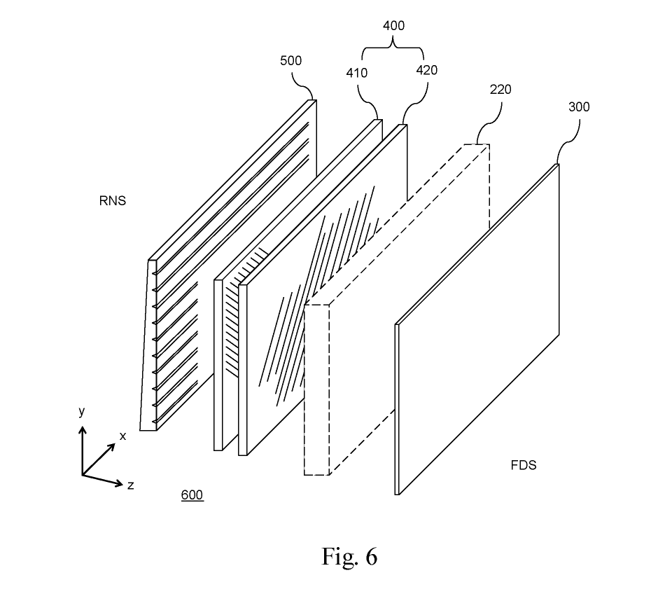

FIG. 6 is an exploded schematic diagram illustrating an exemplary embodiment for the light adjustment assembly in accordance with the present invention. In this embodiment, the grey level inversion compensation film 300, a light enhancement module 400 having dual prism sheets 410 and 420 and a light guide plate 500 form a light adjustment assembly 600. The light adjustment assembly 600 can be applied to any TN mode LCD device, such as the LCD device shown in FIG. 2. While the light adjustment assembly 600 including the light enhancement module 240, 400, the grey level compensation film 230, 300 and the light guide plate 272, 500 is configured with the LCD panel 220 to form the LCD device 200, it is obtained that when a visible brightness is reduced to a half of a front-view brightness (that is viewed from the front normal direction), the viewing angle, also referred to as a half-brightness viewing angle, is less than 20 degrees, after duly measurement.

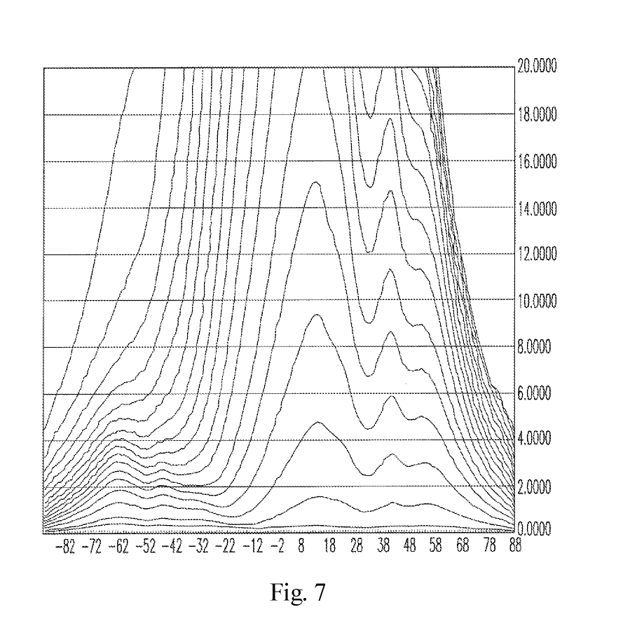

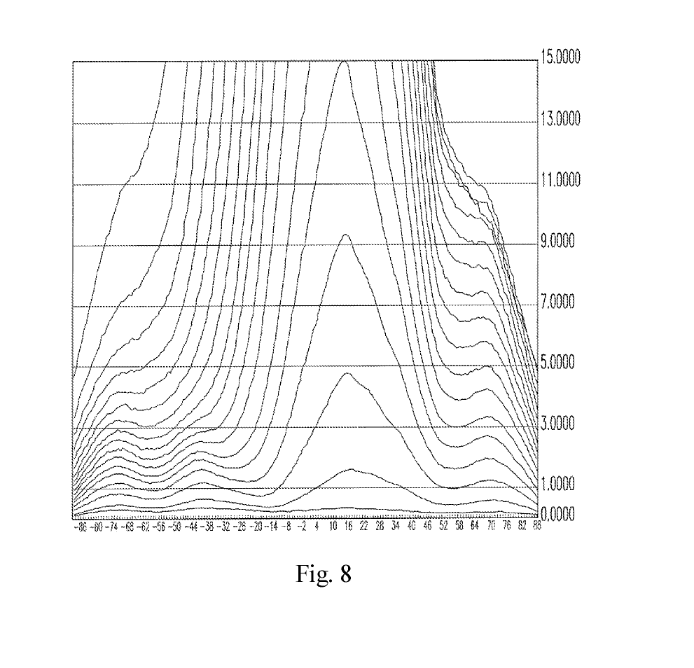

FIG. 7 is a graph showing a first exemplary measurement result of the luminance in relation to a viewing angle at each grey level, while the light enhancement module is in configuration with the grey level compensation film and has the first included angle set in 20 degree and the second included angle set in 110 degree, in accordance with the present invention. FIG. 8 is a graph showing a second exemplary measurement result of the luminance in relation to a viewing angle at each grey level, while the light enhancement module is in configuration with the grey level compensation film and has the first included angle set in 45 degree and the second included angle set in 135 degree, in accordance with the present invention. Referring to FIG. 7 or 6, one can simply conclude that there is none a grey level inversion occurring at any viewing angle.

The LCD panel 220 is preferably a LCD panel having a relatively high aperture ratio (HAR) structure. There are several types of HAR structures disclosed by the Applicant including the U.S. patent application Ser. No. 13/619,307, filed in United States on Sep. 14, 2012, entitled as “liquid crystal display panel and pixel array substrate thereof” for disclosing a HUA type LCD panel structure, the U.S. Pat. No. 6,195,138, filed in US on Jun. 12, 2000, entitled as “Transmission type liquid crystal display having an organic interlayer elements film between pixel electrodes and switching” for disclosing a HAR type LCD panel structure, and the U.S. Pat. No. 5,166,085, filed in US on Apr. 2, 1990, entitled as “Method of manufacturing a thin film transistor” for disclosing a H2AR type LCD panel structure, all of which are hereby incorporated by reference as if fully set forth herein.

As compared with a conventional TN mode LCD device, the above-mentioned three types of LCD panel structures have a relatively high aperture ratio as demonstrated in Table 1. Referring to Table 1, which demonstrates the actually measured aperture ratio (%) for the conventional TN mode LCD device and the three types of HAR LCD panel structures including HUA type, HAR type and H2AR type disclosed by the Applicant.

TABLE 1

| Size and | | | | |
|---|---|---|---|---|
| Resolution | Conventional | H2AR | HAR | HUA |
| of Screen | TN-LCD type | type | type | type |
| 4.3″ WVGA | 24% | 43.10% | 44.28% | 60.04% |
| 4.3″ qHD | 17% | 34.74% | 36.73% | 59.34% |
| 5.3″ HD | 14% | 25.99% | 34.47% | 47.53% |
| 5″ HD | 10% | 23.40% | 31.42% | 44.74% |
| 4.7″ HD | limited | 19.75% | 27.65% | 40.52% |
| 4.3″ HD | limited | 17.18% | 24.83% | 37.24% |

In accordance with the numerical data demonstrated in the Table 1, one can simply determine that the three types of HAR LCD panel structures have a relatively high aperture ratio in comparison with that of the conventional TN mode LCD device. In one embodiment, the LCD panel 220 in LCD device 200 is preferably one of the above-mentioned three types of HAR LCD panel.

The liquid crystal display panel of the liquid crystal display device may comprise a pixel array layer at the rear side. The pixel array layer may comprise a first substrate; a plurality of gate lines disposed on the first substrate; a plurality of data lines disposed on the first substrate and interlaced with the plurality of gate lines, wherein a plurality of pixel areas are defined between the plurality of data lines and the plurality of gate lines; a plurality of thin film transistors corresponding to the plurality of pixel areas respectively, wherein each of the plurality of thin film transistors has a first terminal coupled to a respective one of the plurality of gate lines, a second terminal coupled to a respective one of the plurality of data lines and a third terminal; a first insulation layer covering the plurality of data lines, the plurality of gate lines, the plurality of pixel areas, and the plurality of thin film transistors, and having a plurality of first through holes; a transparent conductive layer covering the first insulation layer for providing a common voltage level, and having a plurality of third through holes; a second insulation layer having a plurality of second through holes, wherein the plurality of first through holes, the plurality of second through holes and the plurality of third through holes are corresponding to a respective one of the plurality of thin film transistors; a plurality of pixel electrodes disposed on the second insulation layer corresponding to the plurality of pixel areas respectively, each of the plurality of pixel electrodes is coupled electrically to the third terminal of the corresponding one of the plurality of thin film transistors through the corresponding ones of the plurality of first through holes, second through holes and third through holes, wherein the second insulation layer is disposed between the transparent conductive layer and the plurality of pixel electrodes, and insulates the transparent conductive layer from the plurality of pixel electrodes. The liquid crystal display panel may further comprises a color filter layer disposed at the display side, corresponding to the pixel array layer and spaced from the pixel array layer; and a twisted nematic liquid crystal layer disposed between the pixel array layer and the color filter layer. The twisted nematic liquid crystal layer has a phase retardation value in a range from 250 to 480, and the twisted nematic liquid crystal layer has a dielectric anisotropy in a range from 3 to 10.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present invention which is defined by the appended claims.

1. A liquid crystal display device, comprising:
a liquid crystal display panel having a display side and a rear side;
a grey level inversion compensation film having a substrate with a plurality of micro-structures formed thereon, and disposed on the liquid crystal display panel on the display side; and
a light enhancement module disposed on the rear side of the liquid crystal display panel, wherein each of the plurality of micro-structures is one selected from a group consisting of a convex micro-lens based structure, a liquid crystal based structure and a combination thereof, wherein the convex micro-lens based structures are juxtaposed with one another, and formed in a two-dimension arrayed formation as a whole on the substrate.

2. (canceled)

3. The liquid crystal display device according to claim 1, further comprising a first polarizer film disposed between the grey level inversion compensation film and the liquid crystal display panel, a second polarizer film disposed between the light enhancement module and the liquid crystal display panel, and a backlight module including a light source and a light guide plate and disposed in back of the light enhancement module toward the rear side.

4. The liquid crystal display device according to claim 3, wherein one of the first and the second polarizer films further has a wide view film disposed therein, and the grey level inversion compensation film is disposed on the first polarizer film.

5. The liquid crystal display device according to claim 3, wherein the light guide plate further has a first surface and a second surface opposite to the first surface and a plurality of grooves formed on one of the first surface and the second surface, and the light guide plate is functioned to provide a half-brightness viewing angle less than 20 degrees, when a visible brightness is reduced to a half of a front-view brightness, wherein the respective grooves have a cross section in a shape being one selected from a group consisting of a V-cut shape, a triangular shape, a rectangular shape, a circular shape, a polygon shape, an arc shape and a combination thereof.

6. (canceled)

7. The liquid crystal display device according to claim 1, wherein each of the plurality of convex micro-lenses has a diameter in a range from 0.3 μm to 300 μm and the plurality of convex micro-lenses is formed on the substrate in an arrayed formation.

8. The liquid crystal display device according to claim 7, wherein the convex micro-lens has a diameter in a range from 20 μm to 30 μm.

9. The liquid crystal display device according to claim 7, wherein a light emitted from the liquid crystal display panel and passing through the convex micro-lens is refracted in a relatively large refracting angle by the convex micro-lens.

10. The liquid crystal display device according to claim 1, wherein the light enhancement module further comprises a first and a second prism sheets, wherein each of the first and the second prism sheets is aligned and overlapped with each other contiguously or adjacently, includes a plurality of prism units, each of which prism units a plurality of ridge lines and valley lines, and has a first arrangement orientation and a second arrangement orientation based on the plurality of ridge lines and valley lines.

11. The liquid crystal display device according to claim 10, wherein there is a first included angle between the first arrangement orientation and a reference orientation to be in a range from 10 to 80 degrees, and a second included angle between the second arrangement orientation and the reference orientation to be in a range from 100 to 170 degrees.

12. The liquid crystal display device according to claim 11, wherein when the first included angle is 20 degrees, the second included angle is 110 degrees, and when the first included angle is 45 degrees, the second included angle is 135 degrees.

13. The liquid crystal display device according to claim 3, wherein there is a light adjustment assembly formed by including the grey level inversion compensation film, the light enhancement module and the light guide plate and is functioned to provide a half-brightness viewing angle less than 20 degrees, when a visible brightness is reduced to a half of a front-view brightness.

14. The liquid crystal display device according to claim 1, wherein the liquid crystal display panel further comprises:
a pixel array layer at the rear side, comprising:
a first substrate;
a plurality of gate lines disposed on the first substrate;
a plurality of data lines disposed on the first substrate and interlaced with the plurality of gate lines, wherein a plurality of pixel areas are defined between the plurality of data lines and the plurality of gate lines;
a plurality of thin film transistors corresponding to the plurality of pixel areas respectively, wherein each of the plurality of thin film transistors has a first terminal coupled to a respective one of the plurality of gate lines, a second terminal coupled to a respective one of the plurality of data lines and a third terminal;
a first insulation layer covering the plurality of data lines, the plurality of gate lines, the plurality of pixel areas, and the plurality of thin film transistors, and having a plurality of first through holes;
a transparent conductive layer covering the first insulation layer for providing a common voltage level, and having a plurality of third through holes;
a second insulation layer having a plurality of second through holes, wherein the plurality of first through holes, the plurality of second through holes and the plurality of third through holes are corresponding to respective ones of the plurality of thin film transistors;
a plurality of pixel electrodes disposed on the second insulation layer corresponding to the plurality of pixel areas respectively, each of the plurality of pixel electrodes is coupled electrically to the third terminal of the corresponding one of the plurality of thin film transistors through the corresponding ones of the plurality of first through holes, second through holes and third through holes, wherein the second insulation layer is disposed between the transparent conductive layer and the plurality of pixel electrodes, and insulates the transparent conductive layer from the plurality of pixel electrodes; and
a color filter layer disposed at the display side, corresponding to the pixel array layer and spaced from the pixel array layer; and
a twisted nematic liquid crystal layer disposed between the pixel array layer and the color filter layer.

15. The liquid crystal display device according to claim 14, wherein the twisted nematic liquid crystal layer has a phase retardation value in a range from 250 to 480, and the twisted nematic liquid crystal layer has a dielectric anisotropy in a range from 3 to 10.

16. The liquid crystal display device according to claim 14, wherein each of the plurality of pixel areas has at least one of the openings disposed above the thin film transistors, and the at least one of the opening is one selected from a group consisting of an S-shaped pattern, an S-like pattern, an E-shaped pattern, an E-like pattern, a snakelike pattern, a zigzag pattern, a zigzag-like pattern, a comb-shaped pattern, a comb-like pattern, a pattern of a plurality of strips and a combination thereof.

17. The liquid crystal display device according to claim 14, further comprising an opening provided through the transparent conductive layer and disposed between the first insulation layer and the second insulation layer.

18. The liquid crystal display device according to claim 17, wherein the opening is disposed above one of the thin film transistor and the gate line.

19. A liquid crystal display device having a liquid crystal display panel having a grey level inversion, a first side and a second opposite side, comprising:
a compensation film having a substrate with a plurality of micro-structure formed thereon, and disposed on the first side for compensating the grey level inversion; and
a light enhancement module having a first and a second prism sheets and disposed on the second opposite side for enhancing and collimating a light emitting from the second opposite side, wherein the first prism sheet has an edge and a first featured orientation deviating from the edge in a range from 10 to less than 20 degrees and the second prism sheet has a second featured orientation deviating from the edge in a range from 100 to less than 110 degrees.

20. (canceled)

21. The liquid crystal display device according to claim 19, wherein the first and the second prism sheets are parallel to each other.
